(19) United States
(12) Patent Application Publication
(10) Pub. No.: US 2008/0240659 A1
(43) Pub. Date: Oct. 2, 2008

(54) COUPLING DEVICE BETWEEN AN OPTICAL FIBRE AND AN OPTICAL GUIDE INTEGRATED ONTO A SUBSTRATE

(75) Inventor: Christophe KOPP, Le Fontanil-Cornillon (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/866,059

(22) Filed: Oct. 2, 2007

(30) Foreign Application Priority Data
Oct. 4, 2006 (FR) 06 54090

(51) Int. Cl. G02B 6/36

(52) U.S. Cl. 385/88

(57) ABSTRACT

The disclosure relates to an optical device comprising an assembly and optical coupling cover between at least one waveguide integrated onto a first support and at least one optical fibre integrated onto a fibre connector, wherein the cover is capable of being fixed to the first support and comprises:
one or several grooves designed to allow to the cover to nest with the connection pins of the optical fibre connector,
at least one other groove equipped with longitudinal sides, a base, and a wall forming an angle that is not nil with the base and the sides, wherein said other groove is designed to be positioned in the extension of the optical axis of the fibre and so that said wall is located opposite the fibre,
an optical system positioned at the level of a wall of said other groove, capable of deviating towards the fibre a luminous beam from the wave guide and/or deviating towards the wave guide a luminous beam from the optical fibre.

### TECHNICAL FIELD

This invention relates to the field of optical systems for data transmission. One purpose of the invention is to propose an improved assembly and coupling device between a first wave guide, for example an optical wave guide integrated onto a substrate and a second wave guide, for example an optical fibre fitted in a connector. The device of the invention allow a removable assembly with the fibre. The invention may apply in particular to wide band optical buses, from micro methodor to micro methodor, from micro methodor to memory, and to emitter/receiver devices for telecommunication optical networks.

### PRIOR ART

The implementation of planary optical guide devices, may permit to obtain, on a single substrate or on a single chip, complex optical beam management functions such as multiplexing, demultiplexing, modulation or spectral routing. These functions may be implemented for both optical connections over very short distances, for example of around one millimetre, and created between chips, or optical connections over very long distances, for example of around several kilometres, as in a metropolitan network.

The integration of many optical functions onto a single chip requires advanced miniaturisation of the optical circuits, and in particular miniaturisation of the section of the planary optical guides to dimensions of less than a micron. For transmissions over medium and long distances, for example several metres to several kilometres, the preferred optical transport medium is optical fibre, whose sectional dimensions remain approximately one to several tenths of a micron. A light coupling system between a planary optical guide and an optical fibre is provided to compensate for a dimensional de-adaptation between these two components.

An example of an optical coupling device of the prior art is illustrated in FIG. 1. The coupling is made between a first optical fibre 2, and a wave guide 6, as well as between the wave guide 6 and a second optical fibre 4. The core 8 of the first optical fibre 2 is coupled to the wave guide 6 by means of a first diffraction network 12 whose size is around 10 μm×10 μm, whilst the core 10 of the second optical fibre 2, is coupled to the wave guide 6 by means of a second diffraction network 14 which may be of the same size as the first. The wave guide 6 comprises a first narrowed part 6a connecting the first diffraction network and a central part 6b of a critical dimension of around several hundreds of nanometres, as well as a second narrowed part 6c connecting the central part 6b and the second diffraction network 14. The narrowed parts 6a and 6c of the wave guide 6 permit the progressive adaptation of the dimensions of an optical beam emitted from one of the diffraction networks 12, 14, to those of the central part 6b of the guide 6. In this device, in order to adapt the Gaussian beam leaving the diffraction network to the fibre, a diffraction network is used.

The documents US 2006/0022289A1 and WO 2003/088286A2 present different variants of optical coupling devices on substrate, between an optical fibre fixed to the substrate and an optical component integrated onto the substrate, for example in the form of one or several wave guides or a diffraction network. The coupling device comprises a concave mirror permitting the deviation towards the optical component, of a luminous beam emitted from the optical fibre. In this device, the component may be made on the rear face of the substrate whilst the coupling device and the fibre may be fixed to the substrate by means of glue. For this device, once the optical coupling and the fibre are glued to the substrate, the assembly and the setting of the coupling are definitive.

The document US 2004/0156589A1 reveals an optical coupling device integrated onto a substrate and equipped in particular with a diffraction network as well as Bragg mirrors.

There is the problem of finding a new optical coupling device between an optical fibre and an integrated wave guide.

### DESCRIPTION OF THE INVENTION

The invention relates to an optical device comprising an assembly and optical coupling cover between at least one wave guide and at least one optical fibre, wherein the cover is capable of being fixed to a support of the waveguide and comprises:
a substrate,
one or several assembly grooves formed in the substrate designed to allow the cover to nest or interlock with a support of the optical fibre,
at least one other groove formed in the substrate and equipped with longitudinal sides, a base, and a wall creating an angle that is not nil with said base and said longitudinal sides, wherein said other groove is designed to be positioned in the extension of the optical axis of the fibre and so that said wall is positioned opposite the fibre,
an optical system positioned at said wall of said other groove and designed to deviate towards the fibre a luminous beam from the wave guide and/or to deviate towards the wave guide a luminous beam from the optical fibre.

The support of the fibre can be a fibre connector including connector pins. Hence the device of the invention allows a removable assembly with the fibre.

The device may also comprise at least one diffraction network.

The optical device of the invention may further comprise said support of the wave guide. The diffraction network may be connected to said wave guide and integrated or formed on the support of the wave guide.

In one possible embodiment, said wall has an angle that is not nil and different from 90° with respect to the main plane of the substrate, for example an angle of around 54.75° with respect to the main plane of the substrate.

The optical system may comprise: a mirror formed on said wall. The mirror may be a flat mirror angled with respect to the main plane of the substrate. The mirror may be designed to be angled with respect to the optical axis of the fibre and the optical axis of the waveguide.

The optical system may also comprise: a spherical lens. The lens may be glued to the mirror.

The support of the optical fibre may be capable of nesting or interlocking with the optical cover, by means of guide pins capable of nesting or interlocking into the assembly grooves of said cover.

In one possible embodiment, when the optical cover is nested or interlocked with the fibre support, the optical cover may be mobile with respect to the fibre support in a direction parallel to the main direction of the groove.

In one possible embodiment of the device, the wave guide support may be a chip formed from a substrate and equipped with one or several components or elements or functions, electronic and/or optoelectronic. Said chip may be made for example using CMOS technology.

Said support of the optical fibre may be a connector, for example a connector of the MTP/MPO type.

### BRIEF DESCRIPTION OF THE DRAWINGS

This invention will be more clearly understood after reading the description of embodiments provided, purely by way of example and in no way restrictively, in reference to the appended drawings in which:

FIG. 1 illustrates an optical coupling device of the prior art, equipped with two diffraction networks and permitting a coupling on the one hand between a first optical fibre and a waveguide and on the other hand between the waveguide and a second optical fibre,

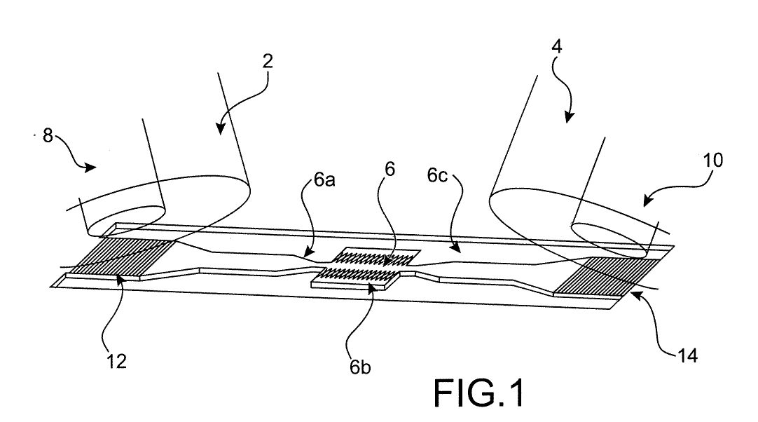

FIG. 2 illustrates, in a cross sectional view, an example of an optical coupling cover of the invention, between an optical fibre mounted on a support interlocked with said cover and a waveguide formed on a chip assembled onto said cover,

FIG. 3 illustrates, in a top view, said chip on which said waveguide is formed and comprises a diffraction network connected to the waveguide,

FIG. 4 illustrates, in a front view, an optical coupling cover of the invention and a chip assembled onto said cover and onto which a waveguide is integrated,

FIGS. 5 to 9 show different settings of the positioning of the optical coupling device of the invention,

FIG. 10 illustrates a perspective view of a V shaped groove made in the optical cover during manufacture, wherein the groove is designed to contain the optical fibre and be equipped with optical means to deviate towards a waveguide a luminous beam from the fibre, or to deviate towards the optical fibre a luminous beam from a waveguide,

FIG. 11 illustrates, in a side view, an example of an optical cover of the invention, equipped with a V shaped groove comprising a spherical lens,

FIGS. 12A-12H illustrate different stages of one example of a fabricating method of welding beads on said optical cover, for its assembly with a chip equipped with at least one waveguide,

FIGS. 13A-13D illustrate different stages of one example of a “flip chip” type assembly method between the optical cover and said chip equipped with at least one waveguide,

FIGS. 14A-14B illustrate variants of waveguides capable of being integrated onto a chip with which the optical coupling cover of the invention is designed to be assembled.

Identical, similar or equivalent parts of the different figures bear the same numerical references in order to make it easier to change from one figure to another.

The different parts shown in the figures are not necessarily to a uniform scale, to make the figures easier to understand.

### DETAILED DESCRIPTION OF SPECIFIC EMBODIMENTS

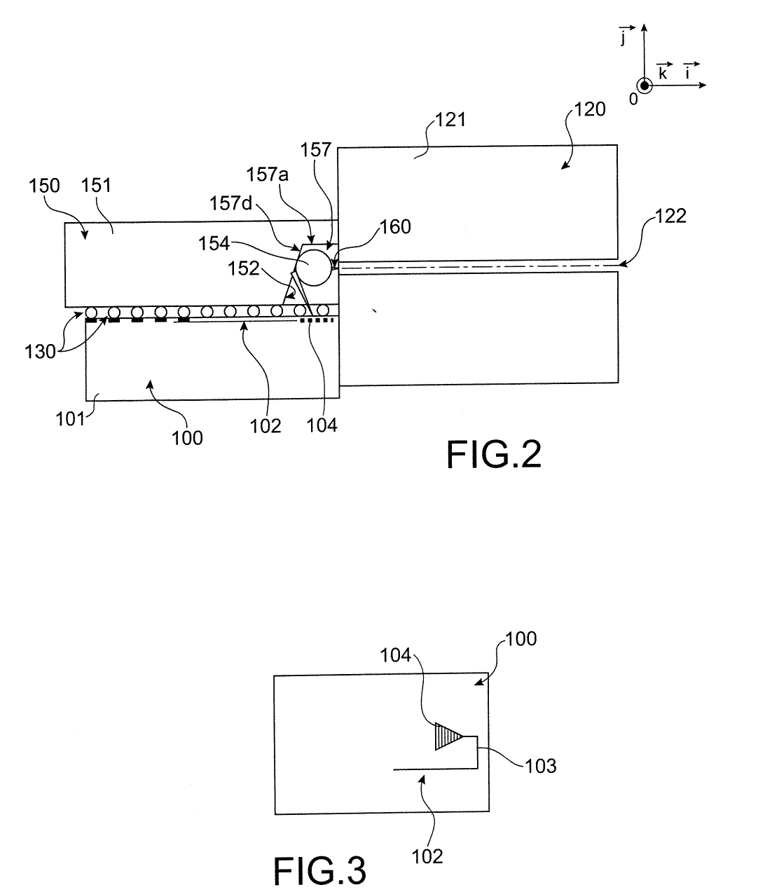

An example of an optical device of the invention will now be provided, in relation to FIG. 2.

This optical device comprises an assembly and optical coupling device between at least one first element 100 comprising at least one first waveguide 102 integrated onto a first support and at least one second element 120 integrated onto a second support comprising at least one second waveguide of a size different to that of the first waveguide and for example greater than that of the first waveguide 102. The second waveguide may be for example an optical fibre 122. The assembly may be made so that the waveguide 102 and the optical fibre 122 are parallel, at least close to the coupling zone. The coupling may be made so that the waveguide 102 and the optical fibre 122 are respectively situated in different parallel planes.

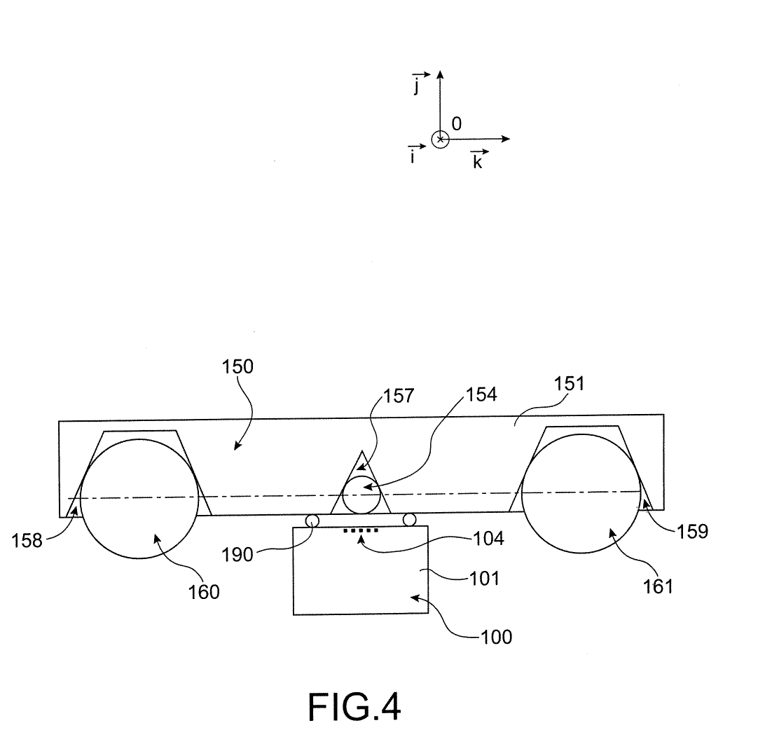

The first element 100 may be for example a chip made using CMOS (Complementary Metal Oxide Semiconductor) technology and formed from a substrate 101, comprising one or several integrated waveguides and in particular the waveguide 102. The chip may be equipped with integrated optoelectronic and/or electronic components, for example transistors and/or for example one or several memories. The first element 100 may also comprise at least one diffraction network 104 provided for the optical coupling with the waveguide 102 and connected to the latter. The diffraction network 104 may be for example designed to create a 2^{nd} order coupling. The waveguide 102 may be also equipped with a bend of 103 to 180°, to make the connection with the diffraction network 104, as shown in FIG. 3 illustrating the first element 100 in a top view.

The second element 120 may be a connector such as for example a MTP®/MPO type connector or an MTP (Multi-fibre Push On) type MPO connector which may be formed by a plastic support 121 into which are inserted one or several optical fibres and in particular an optical fibre reference 122.

The assembly and the coupling between the first element 100 and the second element 120 is made via a device called the “optical cover” 150. The optical cover 150 may be formed from a substrate 151 that may be a semi-conductor, for example silicon based. The optical cover 150 and the first element 100 may be designed to be fixed to one another. The optical cover 150 and the first element 100 may be assembled or hybridised or fixed to one another by means of welding beads 130, for example using a self-aligning “flip-chip” technique. The optical cover 150 may also comprise interconnections and is capable of forming an electrical connection interface between the first element 100 and a housing or a PCB (printed circuit board) onto which a microelectronic device or component may be added. The optical cover 150 and the second element 120 may be assembled by nesting or interlocking. The assembly between the optical cover 150 and the second element 120 is removable so that the optical cover 150 and the second element 120 can be assembled and then disassembled. The optical cover 150 comprises an optical system to deviate a luminous beam designed to pass through the waveguide 102 and the optical fibre 122 and possibly adapt the size of this beam between the waveguide 102 and the optical fibre 122. The optical system may permit in particular a luminous beam from the optical fibre to be deviated towards the waveguide, and/or to deviate a luminous beam from the waveguide towards the optical fibre. The optical system may also permit the size of a luminous beam from the optical fibre to be adapted to the waveguide, and/or to adapt the size of a luminous beam from the waveguide to the optical fibre. The optical system may comprise a mirror 152, as well as a lens 154 associated to the mirror. The mirror 152 may be formed in the substrate 151 and be fitted so that the reflective surface of the latter creates an angle α that is not nil with the main plane of the substrate 151 (defined by a plane passing through the substrate and parallel to the plane [O; \vec{i}; \vec{k}] with an orthogonal reference [O; \vec{i}; \vec{j}; \vec{k}] shown on FIG. 2). The mirror 152 may also form an angle α that is not nil with the optical axis of the waveguide 102 and the optical axis of the fibre 122. By optical axis of the waveguide 102, it is meant the main direction of the guide 102 or a direction defined in FIG. 2 by an axis passing through the guide 102 and parallel to the vector \vec{i} of the orthogonal reference [O; \vec{i}; \vec{j}; \vec{k}]. By optical axis of the fibre 122, it is meant the main direction of the fibre 122 or a direction defined in FIG. 2 by an axis passing through the fibre 122 and parallel to the vector \vec{i}. The lens 154 may be spherical and in the form of a ball of a diameter of between for example 0.3 mm and 0.5 mm. The lens 154 is located in a groove 157 or a channel 157 formed in the substrate 151, and placed in the extension of the fibre 122. The groove 157 is equipped with a base 157a opposite the first element 100 and with longitudinal sides (not shown) extending in a direction parallel to the main plane of the substrate 151. In one possible embodiment, the longitudinal sides of the groove 157 may form a ‘V’ representative of the manner in which they have been formed in the substrate 151.

The lens 154 may be glued to the mirror 152, wherein the latter may be formed on a wall 157d of the groove 157 located facing or opposite the fibre 122, and forming an angle that is not nil with the sides of the groove as well as with a normal to the main plane of the substrate 151. The mirror 152 may be formed with a metallic deposit for example aluminium or gold based.

The adjustment of the optical system is provided so that a luminous beam from the fibre 122 and passing through the optical system is deviated by the latter in direction of the diffraction network 104 connected to the waveguide 102. In one possible embodiment, the diffraction network 104 may have a pointed or elongated form, and/or be an anamorphous type network or be a taper type network.

The path of a luminous beam 160 leaving the fibre 122 may be as follows: the beam spreads along the groove 157, then passes through the spherical lens 154 and is then deviated by the mirror, and is projected onto the diffraction network 104 before being coupled in the waveguide 102. The angle of incidence of the luminous beam on the network 104 may be for example around 19.48° for a tilt angle of the mirror 152 of around 54.74° with respect to the main direction of the wave guide and/or the optical fibre.

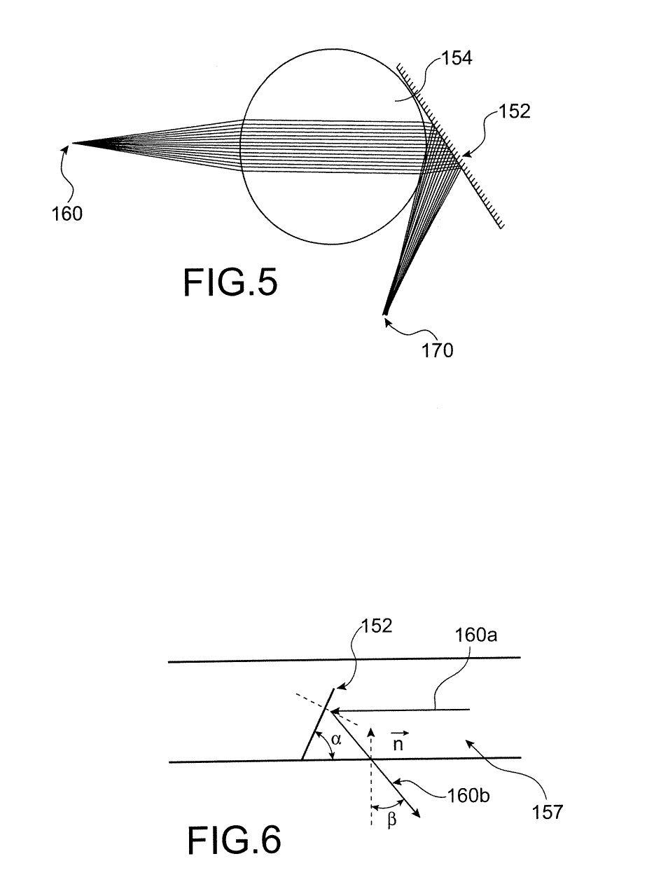

In FIG. 4, the substrate 101 of the first element 100 and the substrate 151 of the optical cover 150 are shown in a front view. The optical cover 150 further comprises channels 158, 159, on either side of the channel 157 comprising the optical system. The channels 158, 159, are designed to accommodate connector pins 160, 161 or guide pins of the connector. The channels 158, 159, extend in a direction parallel to that of the channel 157 (wherein the direction of the channel is parallel to the vector \vec{i} of the orthogonal reference [O; \vec{i}; \vec{j}; \vec{k}] in FIG. 4). The channels 158, 159, permit assembly by interlocking or overlapping or nesting of the fibre support 120 with the cover 150. The distance separating the connection pins 160, 161, of the connector may be for example around 4.6 mm.

In one possible implementation, the position of the optical system of the coupling cover 150 with respect to the fibre 122, may be adjusted or pre-set. The position of the cover 150 with respect to the optical fibre 122 in a direction following the optical axis of the latter (parallel to a vector \vec{i} of the orthogonal reference [O; \vec{i}; \vec{j}; \vec{k}]) may be adjusted and set. By modifying the longitudinal position of the cover 150 with respect to the fibre 122, or by moving the fibre 122 in a direction parallel to the groove 157, the magnification of the optical system may be adjusted.

The position of the cover 150 with respect to the optical fibre 122 in a direction that is orthogonal to the main plane of the substrate 151 (wherein the main plane of the substrate 151 is a plane defined by a plane passing through the latter and parallel to the plane [O; \vec{i}; \vec{k}] of the orthogonal reference [O; \vec{i}; \vec{j}; \vec{k}]), may be also adjusted and set. By modifying the position of the height of the fibre 122 with respect to the lens 154, or by moving the cover 150 with respect to the fibre 122 in a direction orthogonal to the main plane of the substrate 151, the angle of incidence of the luminous beam on the first element 100 and in particular on the diffraction network 104 may be adjusted.

The lens 154 may be provided with a range length of less than 100 micrometers or 200 micrometers, wherein the range length is here defined as the minimum distance between the image focal length and the edge of the lens 154. The following table provides a set of EFL focal values and BFL range values, for several spherical lenses of the type referenced 154 and capable of being integrated onto the optical coupling device, according to the DIA diameter and the refraction index of these lenses.

| DIA | n | EFL | BFL |
|---|---|---|---|
| 0.3 | 1.77 | 0.172 | 0.022 |
| 0.5 | 1.77 | 0.287 | 0.037 |
| 1 | 1.77 | 0.575 | 0.075 |
| 0.3 | 1.5 | 0.225 | 0.075 |
| 0.5 | 1.5 | 0.375 | 0.125 |
| 1 | 1.5 | 0.75 | 0.25 |

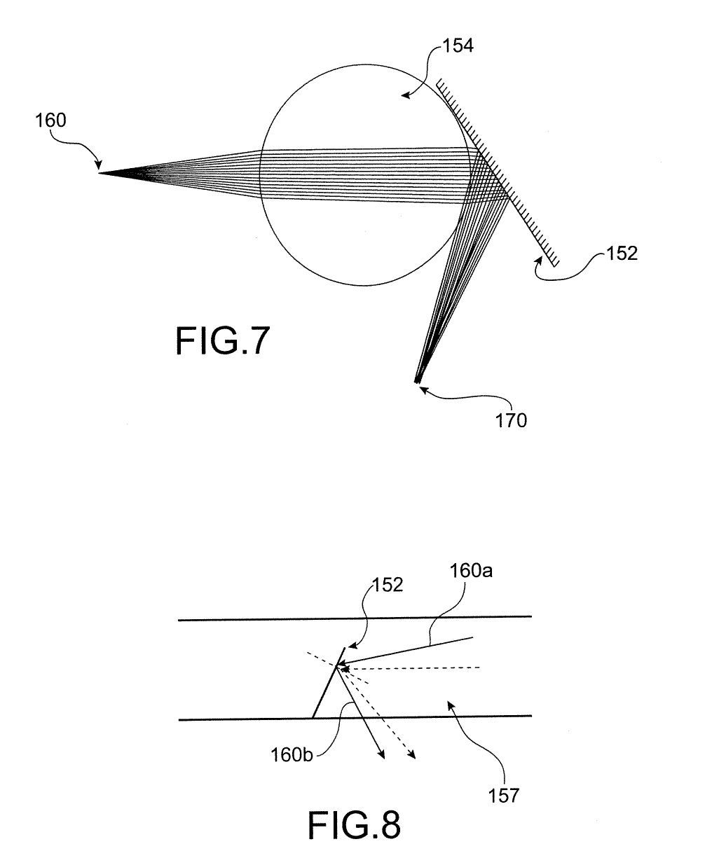

A case may be considered for example where the optical fibre 122 is a digital opening single mode fibre ON for example of around 0.14 and the lens 154 has a diameter of around 0.5 mm and a refraction index n=1.5. FIG. 5 illustrates the propagation of a beam 160 issued from the optical fibre 122, for a setting designed to obtain magnification system m≈1, wherein the fibre 122 is located at a distance of around 450 μm from the lens 154 and the point image 170 is located at a distance of around 50 μm from the lens 154, where α is the angle that mirror 152 forms with the main direction of the groove 157. For an incident beam 160a substantially parallel to the main direction of the groove 157, a reflected beam 160b is obtained with an angle β with respect to a normal approximately equal to 19.48° (FIG. 6). In FIG. 7, the same optical system as previously described in relation to FIG. 5 is illustrated, but with distances between the fibre 122 and lens 154 that are adjusted so as to obtain increased magnification m≈1.5. To obtain such a magnification, the fibre 122 may be placed at a distance of around 375 μm from the lens 154. The point image 170 may be situated at a distance of around 200 μm from the lens. An adjustment of the angle of incidence is illustrated in FIG. 8. This adjustment may be obtained by offsetting the fibre 122 in the object plane with respect to the initial optical axis, which has the effect of modifying the angle of incidence of the incident beam 160a on the mirror 152 and also modifying the tilt of the reflected beam 160b. FIG. 9 uses the same optical system as previously seen with the fibre offset by 50 μm from the centre with respect to the initial optical axis in order to obtain an angle of the reflected beam with respect to the vertical axis of approximately 12° instead of 19.48°.

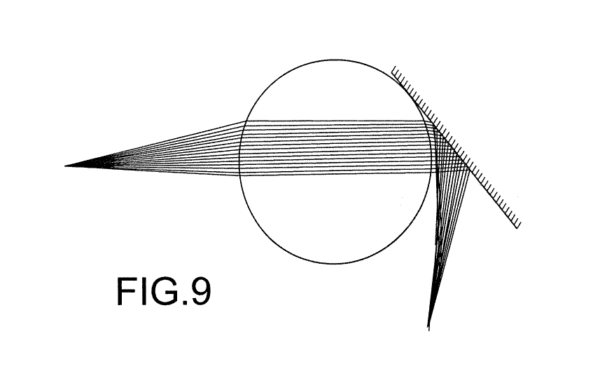

FIG. 10 illustrates, in a perspective view, a channel or a V shaped groove also formed in a substrate 151 from which the optical cover is designed to be made. The groove may be of the type of that with the reference 157 in FIG. 2, in which an optical system comprising for example the spherical shaped lens 154 and the mirror are designed to be made. The V shaped groove 157 may have longitudinal sides forming an angle for example of around 54.75° with the main plane of the substrate 151, as well as a wall also forming an angle of around 54.75° with the main plane of the substrate and that is not nil with the longitudinal sides. Such a groove 157 may be obtained by anisotropic chemical etching, for example using KOH or NaOH or NH₄OH in the case of the substrate 151 being monocrystalline silicon based, wherein the etching is carried out in the <111> plane. The depth is determined by the width of the chemical etching strip that defines the limit planes. Other channels or grooves (not shown in this figure) such as those with the references 158, 159 are also made in the substrate 151 using the etching method that has just been described.

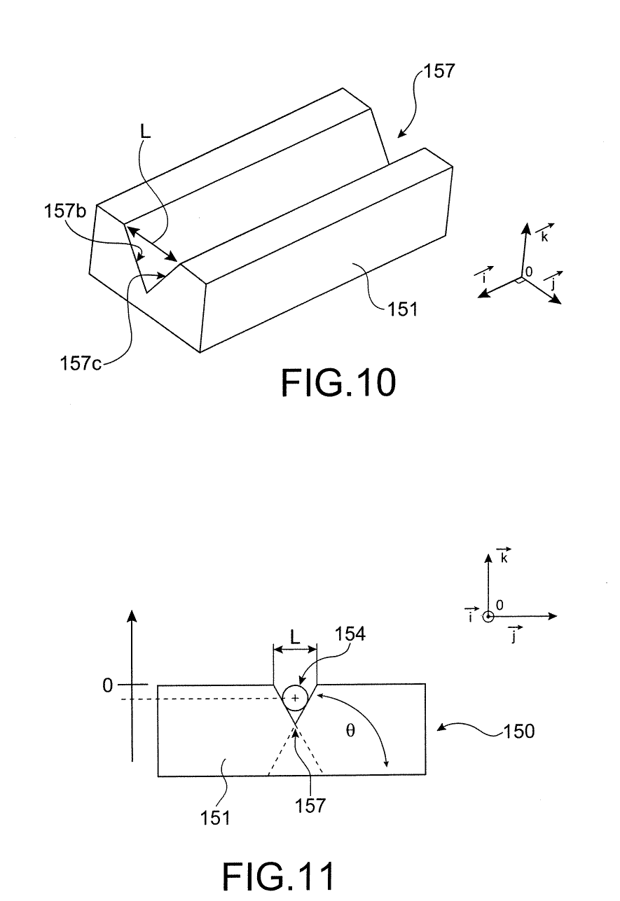

In FIG. 11, the groove 157 made in the substrate 151 of the optical cover 150, is a transversal cross sectional view and is equipped with the spherical shaped lens 154. The width L of this groove 157 at the surface of the substrate 151 may be between for example 0.3 mm and 1 mm.

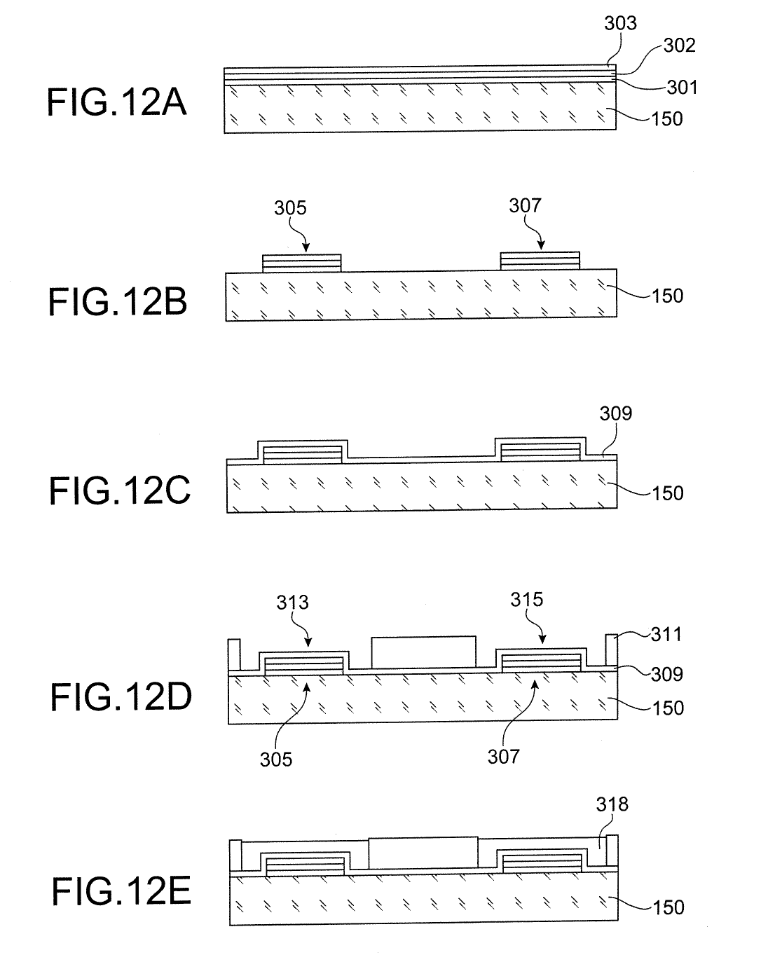

A method for fabricating the welding beads 130 on the optical cover 150 will now be given in relation to FIGS. 12A to 12H. On the rear face of the optical cover 150, or on the face of the cover 150 on which the channels 157, 158, 159, are made, a metallic layer is formed, for example titanium based, and/or nickel, and/or palladium, and/or gold, or a stack of several metallic layers 301, 302, 303, for example a layer of titanium, then a layer of nickel, then a layer of palladium (FIG. 12A).

Subsequently, pins 305, 307 are formed in the metallic layers 301, 302, 303, for example using a photolithographic method in which a layer of resin is deposited on the stack of metallic layers 301, 302, 303; this layer of resin is insulated for example using UV radiation and through a mask, in order to create a mask formed by resin patterns, then the metallic layers 301, 302, 303, are etched through the mask so as to form the pins 305, 307. The mask is then removed (FIG. 12B).

Subsequently, a continuous metallic base 309 is deposited, for example titanium based (FIG. 12C).

Then, a resin mask 311 is formed on said continuous metallic base 309, wherein the resin mask 311 comprises holes 313, 315 which reveal the pins 305, 307 covered by the metallic base 309 (FIG. 12D).

Subsequently, the holes 313, 315 are filled using a fusible material 318, for example a fusible metal such as indium or a gold-tin alloy, so as to form the zones of fusible material 318 covering the pins. The holes 313, 315, may be filled for example by electrolytic growth (FIG. 12E).

Subsequently, the resin 311 is removed (FIG. 12F), then the continuous metallic base 309 is etched on both sides of each of the fusible material zones 318 (FIG. 12G).

Subsequently (FIG. 12H), the fusible material is melted again in order to provide a spherical form to the fusible material zones 318, and thus create the welding beads 130.

Once the welding beads 130 are formed, the optical cover 150 and the first element 100 are assembled using the welding beads 130. An assembly technique called “flip-chip” may be used. The welding beads 130 ensure both the assembly and electrical connections. The use of a flip-chip type report permits the self-alignment of the cover 150 with respect to the first element 100.

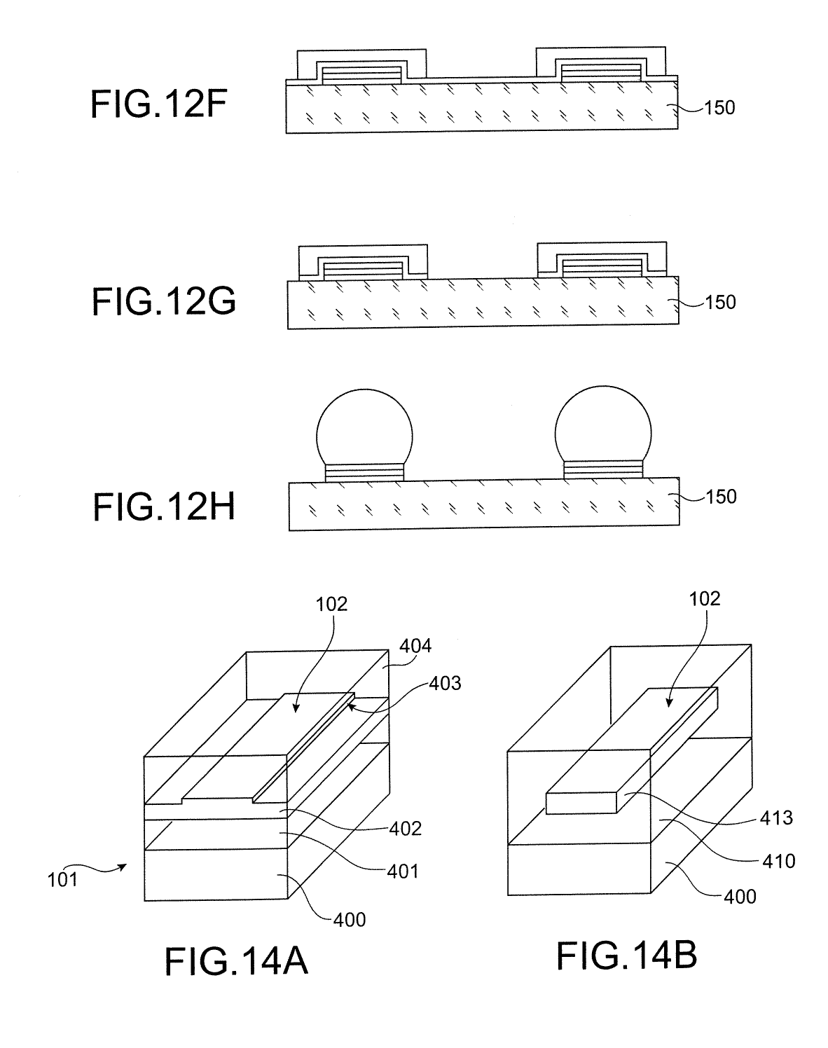

A hybridisation or assembly of the cover 150 on the first element using the “flip-chip” method is illustrated in FIGS. 13A to 13D. Such a method uses the surface tension forces exerted by a molten spot weld on a part to be welded and permits self-alignment of the cover 150 with the first element 100. First, the beads 130 of a fusible solder are placed on the conductive zones 159 of the cover 150 positioned precisely by photolithography. The beads may be made of example a Au—Sn eutectic alloy, or Indium, and are brought into contact with connection pins 109 formed on the first element 100 and also positioned precisely by photolithography (FIGS. 13A to 13D). In this way, electrical contact and thermal contact are created simultaneously between the cover and the first element 100. The assembly or hybridisation may be carried out as described in the document FR 2 807 168.

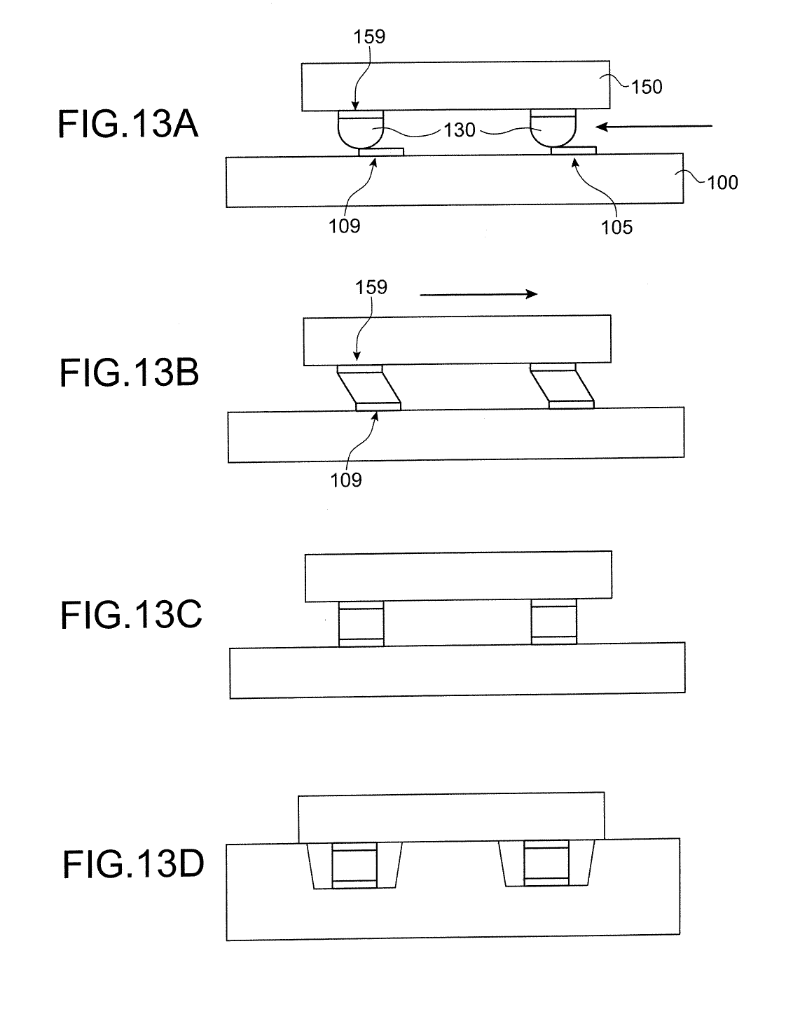

In FIGS. 14A and 14B, a first example and a second example of implementations of the waveguide 102 formed on the substrate 101 of the first element 100 are shown.

In the first example of implementation (FIG. 14A) the waveguide 102 is a guide of the “peak” type, formed by an etched parallelepipedal block 403 made of a semi-conductor material, resting on a layer 402 made of said semi-conductor material, for example Si. The layer 402 on which the etched parallelepipedal block 403 rests, may be the semi-conductor layer of a semi-conductor on insulator substrate which itself rests on the insulator layer 401 of said substrate. The etched parallelepipedal block 403 and the layer 402 may be covered by an insulator layer 404 which acts as an optical sheath, and for example is SiO₂ based.

In the second example of implementation (FIG. 14B) the waveguide 102 is a guide of the “ribbon” type, formed by a parallelepipedal block 413 coated with an insulating layer 410 for example SiO₂ based, acting as a sheath. Typically, the wave guides which have just been described present an optical mode of dimension: for example 0.5×0.2 μm² for the ribbon type guide, and 0.9×0.4 μm² for the peak type guide. These guides have small losses in the TE polarisation mode, for example between 0.4 and 5 dB/cm depending on the material and the type of guide. Other materials may be used to make this type of guide, for example silicon doped with phosphorous, or boron, or germanium, or an inorganic polymer made with the Sol-Gel method, a resin or a polymer. Other fabricating techniques such as laser writing directly on photosensitive material, for example, may also used.

1. Optical device comprising an assembly and optical coupling cover between at least one wave guide and at least one optical fibre, wherein the cover is designed to be fixed to a waveguide support and comprises:
a substrate,
one or several grooves formed in the substrate designed to allow connector pins of a connecter of the optical fibre to nest with the cover,
at least one other groove formed in the substrate and equipped with longitudinal sides, a base, and a wall forming an angle that is not nil with said base and said longitudinal sides, wherein said other groove is designed to be placed in the extension of the optical axis of the fibre and so that said wall is located opposite the fibre,
an optical system positioned at the level of said wall of said other groove and designed to deviate towards the fibre a luminous beam from the waveguide and/or to deviate towards the waveguide a luminous beam from the optical fibre.

2. Optical device according to claim 1, characterised in that said wall forms an angle that is not nil and different to 90° with respect to the main plane of the substrate.

3. Optical device according to claim 1, the optical system comprising: a mirror covering said wall.

4. Optical device according to claim 3, wherein the optical system comprises: a spherical lens glued to the mirror.

5. Optical device according to claim 1, said support of the waveguide being fixed to said cover by means of welding beads.

6. Optical device according to claim 1, at least one diffraction network resting on the support of the waveguide and being connected to said waveguide.

7. Optical device according to claim 1, wherein when the optical cover is interlocked with the fibre support, the optical cover is mobile with respect to the fibre support in one direction parallel to the main direction of the groove.

8. Optical device according to claim 1, the support of the waveguide being a chip formed from a substrate and equipped with one or several electronic and/or optoelectronic components.
